(19) United States
(12) Patent Application Publication
(10) Pub. No.: US 2026/0253342 A1
(43) Pub. Date: Aug. 27, 2026

(54) AUGMENTED REALITY GASKET STRESS SIMULATOR FOR BOLTED JOINT ASSEMBLY TRAINING

(71) Applicant: Teadit N.A., Inc., Pasadena, TX (US)

(72) Inventors: Carlos Daniel Braga Girão Barroso, Rio de Janeiro (BR); Igor Meira, Rio de Janeiro (BR); Leonardo Rocha de la Roca, Rio de Janeiro (BR)

(21) Appl. No.: 19/064,018

(22) Filed: Feb. 26, 2025

(51) Int. Cl. G06T 19/00

(52) U.S. Cl. CPC G06T 19/006; G06T 2219/012

(57) ABSTRACT

An augmented reality gasket stress simulator for bolted joint assembly training includes a test rig including a pair of flanges and a plurality of bolts securing the flanges together and a tool for tightening the plurality of bolts. The bolts or the tool include one or more sensors to collect data representing the axial stress of each bolt. The simulator includes a processing unit configured to receive the bolt stress data from the sensors and compute a gasket stress distribution based on the bolt stress data and an augmented reality visualization device configured to overlay a virtual representation of a gasket onto a real-world view of the test rig.

### TECHNICAL FIELD

The present disclosure relates, in general, to a flange and gasket assembly training simulator, and in particular, a simulator of gasket stress distribution in augmented reality to assist training of bolted joint assembly.

### BACKGROUND

The maintenance of piping systems in industrial plants is crucial for ensuring the safety, efficiency, and integrity of operations. Leaks within these systems can result in significant financial losses, operational downtime, and, in extreme cases, catastrophic accidents.

A key aspect of piping system maintenance is the proper assembly of flange joints, which are often considered one of the weaker components in a piping network. Bolted flange joints are used to connect pipes to various equipment, such as heat exchangers, pumps, pressure vessels, and flow meters. Incorrect assembly of these joints is a primary source of leaks, as it can compromise the integrity of the sealing gasket, creating potential leak paths.

Industry standards, such as the ASME PCC-1 Pressure Boundary Bolted Flange Joint Assembly, provide detailed instructions on safe and effective gasket installation. These guidelines include recommendations for fastening torque and bolt sequencing, both critical factors in ensuring a reliable, leak-free joint.

Despite the availability of these guidelines, they are frequently not adhered to in practice. A significant contributor to gasket failures is improper installation, often due to insufficient training or lack of awareness of proper assembly techniques. Unqualified personnel assembling flanged joints can inadvertently cause improper sealing, leading to leaks.

Therefore, there is a clear need for improved educational resources—whether physical tools, digital platforms, or other instructional methods—to raise awareness of and promote adherence to standardized gasket installation practices. These resources would help mitigate the risk of leaks caused by improper installation, thereby reducing operational disruptions and enhancing the overall safety and reliability of industrial plants.

### SUMMARY OF THE DISCLOSURE

The present disclosure aims to provide an innovative educational tool designed to enhance the training process for gasket assembly by incorporating augmented reality (AR) technology. This tool offers real-time visualization of gasket stress distribution, enabling users to observe and interact with the stress dynamics during the assembly process.

A key feature of this tool is its ability to display how internal gasket stresses evolve as various assembly parameters are adjusted. These parameters include factors such as bolt lubrication, the type and size of tightening tools (e.g., wrenches, torque wrenches, etc.), different gasket materials, and the specific bolt tightening sequence. Each of these variables can significantly influence the final assembly outcome, and the tool disclosed herein facilitates the gasket stress distribution visualization of numerous scenarios for a comprehensive learning experience.

By providing real-time feedback on gasket stress distribution, the tool disclosed herein allows users to understand how each assembly element affects the gasket's performance. This helps users grasp the importance of following recommended procedures, such as correct torque application and tightening order.

Improper assembly techniques can lead to uneven stress distribution, which may result in leakage. The tool disclosed herein serves as a visual aid in preventing these common errors during gasket installation.

Furthermore, the educational tool disclosed herein is designed to accommodate a wide range of training environments and assembly configurations. It can simulate stress behavior for various gasket types and materials, making it versatile for use in different industrial applications.

Ultimately, the tool, system, and methods of the present disclosure enhance gasket assembly training by offering an interactive, dynamic, and data-driven learning tool that improves understanding of the critical aspects of flange joint assembly and promotes adherence to industry standards.

The gasket materials available for gasket stress distribution visualization include, but are not limited to compressed fiber gaskets; metallic gaskets such as spiral wound gaskets and camprofile gaskets; expanded PTFE gaskets; restructured PTFE gaskets; and/or skived PTFE gaskets.

The assembly training test rig includes, but is not limited to, an ASME B16.5 blind flange DN 4″ class 150 # with eight instrumented ⅝″ bolts, where data about each bolt axial stress is collected and used as input for the gasket stress distribution. Indeed, the test rig may include a pair of flanges of any size and pressure class with any number of bolts of any size.

### BRIEF DESCRIPTION OF THE DRAWINGS

The following figures illustrate embodiments of the subject matter disclosed herein. The claimed subject matter may be understood by reference to the following description taken in conjunction with the accompanying figures, in which:

FIG. 1A is an isometric projection view of a test rig according to an embodiment of the present disclosure.

FIG. 1B is an isometric projection view of the test rig of FIG. 1A with an augmented reality gasket stress simulator according to an embodiment of the present disclosure.

FIG. 2 is a color scale representing the gasket stress distribution according to an embodiment of the present disclosure.

FIG. 3 is a perspective view of a user interface device of an augmented reality tool during a gasket assembly process according to an embodiment of the present disclosure.

FIG. 4 is a method of training according to an embodiment of the present disclosure.

### DETAILED DESCRIPTION

The following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

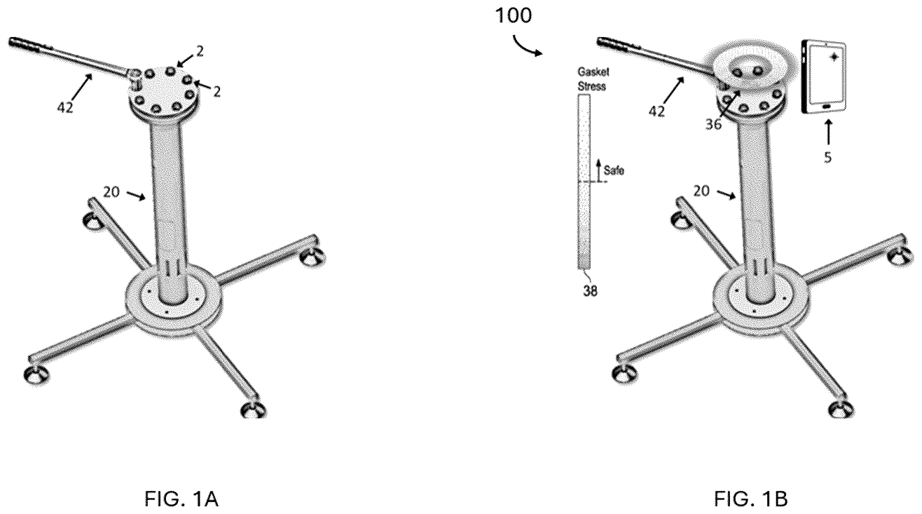

Referring to FIG. 1A, an assembly training test rig 20 is shown. In some embodiments, the assembly training test rig 20 includes an ASME B 16.5 blind flange DN 4″ class 150 #with eight instrumented ⅝″ bolts 2. In some embodiments, each instrumented bolt 2 is equipped with sensors to collect data on axial stress, which is used as input for the gasket stress distribution visualization.

The assembly training test rig 20 includes a torque wrench 42 to apply torque to the instrumented bolts 2 during the assembly process. In some embodiments, the torque wrench 42 is equipped with a sensor to collect data on axial stress, which is used as input for the gasket stress distribution visualization. In some embodiments, the bolts 2 and the torque wrench 42 each include sensors. In some embodiments, only the torque wrench 42 includes a sensor, which may enable any bolted flange connection to become the test rig, since instrumented bolts are not necessary.

In FIG. 1B, the same assembly training test rig 20 is shown along with an augmented reality visualization tool including a device 5, which is used to visualize the augmented reality virtual gasket 36 with the stress distribution embedded in it (collectively, the augmented reality tool 100). The augmented reality elements, including the virtual gasket 36 and stress distribution color scale 38, are overlaid onto the real-world view of the assembly, providing an interactive training experience.

The augmented reality tool 100 operates by processing real-time data collected from the instrumented bolts 2 and/or torque wrench 42. As the bolts 2 are tightened using the torque wrench 42, the sensors measure the axial stress applied to each bolt. This data is then transmitted to the device 5, which computes the corresponding gasket stress distribution. The virtual gasket 36 displayed on the device 5 shows a color-coded representation of the stress distribution, with the color scale 38 indicating different stress levels.

When using the torque wrench 42 as data input instead of the instrumented bolts, each torque is stored in a storage unit of the device 5 and used as reference to calculate the bolts'stresses. From the bolts'stresses, the processing unit of the device 5 then creates the virtual gasket 36. In such embodiments, the bolts 2 are not necessarily instrumented. In any embodiment, the processing unit may be a part of the device 5 or a separate device configured to transmit the computed stress distribution to the device 5. The processing unit may be configured to accept input parameters from a user to be used in the stress distribution computation. Such parameters may include gasket size and/or material, bolt material and/or type, and/or desired stress levels.

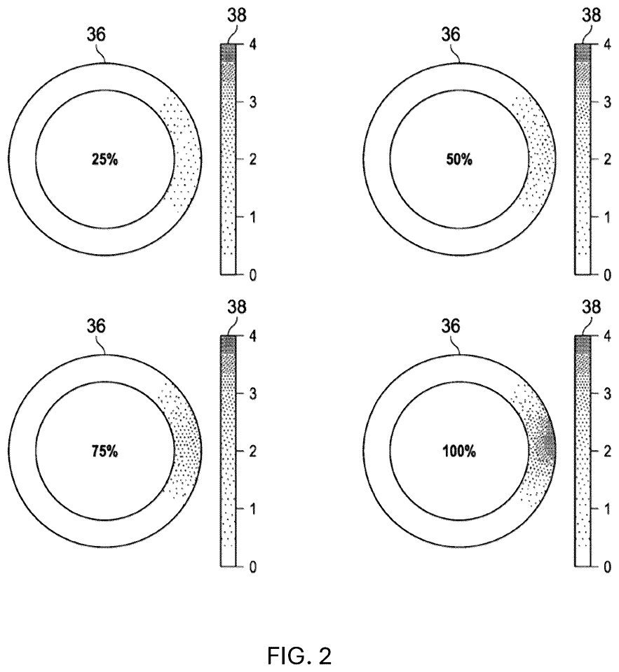

FIG. 2 depicts the virtual gasket 36 along with the color scale 38 in four different configurations, representing varying levels of gasket stress distribution. The configurations illustrate stress levels at 25%, 50%, 75%, and 100% of the color scale stress. Each configuration demonstrates how the stress distribution across the gasket changes as the assembly progresses. In some embodiments, the scale is set in such a way that values below 50% are deemed “unsafe” for installation, while values above 50% are considered “safe”, by implementing gasket parameters of the ASME PCC-1 Pressure Boundary Bolted Flange Joint Assembly into the scale.

The color scale 38 serves as a visual aid to interpret the stress levels within the gasket. For example, colors transitioning from red to blue may represent increasing stress levels, with red indicating low stress areas and blue indicating high stress concentrations. This visualization helps users identify uneven stress distribution, which can lead to potential gasket failure or leakage.

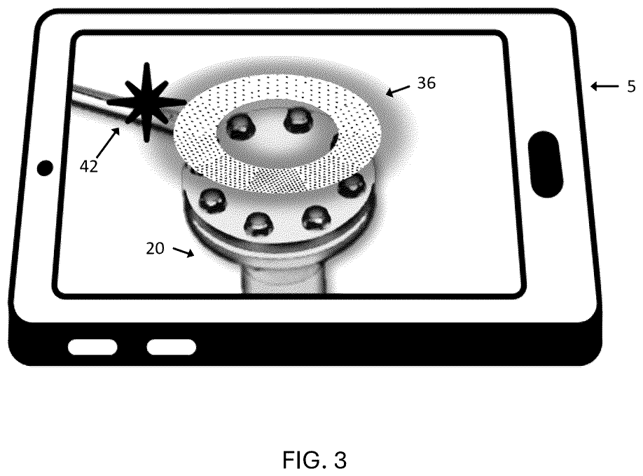

FIG. 3 illustrates the application of the augmented reality tool during the gasket assembly process. In the embodiment depicted, the device 5 is being used to view the augmented reality elements, such as the virtual gasket 36, overlaid onto the real-world elements like the torque wrench 42 and the test rig 20. This integration allows users to interact with the assembly process in a more intuitive and immersive manner, enhancing the learning experience.

The educational tool is capable of simulating how internal gasket stresses evolve as various assembly parameters are adjusted. These parameters include bolt lubrication, the type and size of tightening tools (e.g., wrenches, or the torque wrench 42), different gasket materials, and the specific bolt tightening sequence. By adjusting these variables, users can observe the impact on the gasket stress distribution in real time.

The gasket materials available for stress distribution visualization include, but are not limited to, compressed fiber gaskets, metallic gaskets such as spiral wound gaskets and camprofile gaskets, expanded PTFE gaskets, restructured PTFE gaskets, and/or skived PTFE gaskets. This variety allows users to explore how different gasket materials respond under various assembly conditions.

To further improve the learning experience, the virtual gasket 36 may be 3D-modelled to correspond to the geometry and colors of the actual gasket. Only its effective sealing area is altered to embed the stress color scale.

The assembly training test rig 20 is designed to accommodate a wide range of training environments and assembly configurations. It provides a realistic platform for users to practice gasket assembly techniques while receiving immediate feedback through the augmented reality visualization.

The device 5, utilized for visualizing the augmented reality elements, may be any suitable hardware capable of running augmented reality (“AR”) applications, such as a tablet, computer, smartphone, or AR headset. The device 5 processes the data collected from the instrumented bolts 2 and/or the torque wrench 42 and renders the virtual gasket 36 with the stress distribution overlay.

The torque wrench 42 is an essential tool in the assembly process, allowing users to apply precise torque values to the bolts 2. By varying the torque applied, users can observe the corresponding changes in gasket stress distribution through the augmented reality visualization. This emphasizes the importance of correct torque application and tightening sequences in achieving optimal gasket performance. In training setups, this is often compared with non-recommended methods such as the use of common wrenches to emphasize the discrepancy in the results.

The real-time feedback provided by the tool 100 allows users to understand how each assembly element affects the gasket's performance. For example, improper assembly techniques can lead to uneven stress distribution, potentially resulting in leakage. The visualization helps users identify these issues and correct their techniques, accordingly, following the recommended and standardized methods.

The tool 100 promotes adherence to industry standards by emphasizing the importance of following recommended procedures, such as correct torque application and tightening order. By providing an interactive and dynamic learning environment, the tool 100 enhances users' understanding of critical aspects of flange joint assembly.

The integration of augmented reality technology with the physical assembly process offers a novel approach to gasket assembly training. It provides a comprehensive learning platform that combines theoretical knowledge with practical application, facilitating a deeper understanding of gasket stress dynamics.

The versatility of the tool 100 allows it to be adapted for use in various industrial applications. It can simulate stress behavior for different gasket types and materials, making it suitable for training in industries such as oil and gas, chemical processing, and power generation.

The tool 100 enhances gasket assembly training by offering an interactive, data-driven learning tool. By visualizing gasket stress distribution in real time and allowing users to interact with various assembly parameters, the tool 100 improves understanding of critical assembly practices and promotes better sealing performance in bolted flange joints.

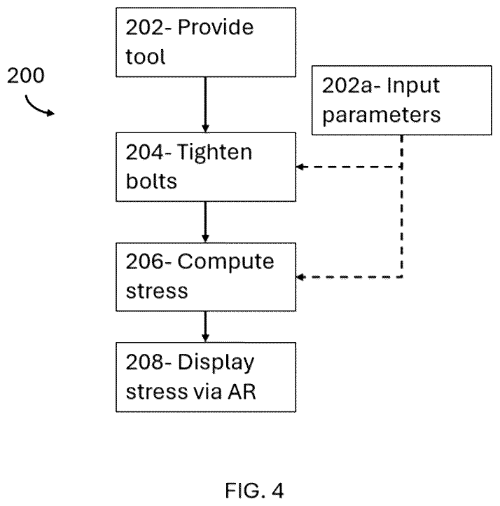

Turning to FIG. 4, a method 200 of using the tool 100 is provided herein. The method 200 includes a step 202 of providing the tool 100 disclosed herein. A step 202a of inputting parameters such as those described above to the processing unit may be included. In step 204, a user tightens the bolts 2 using the torque wrench 42 and sensor data from this operation is transmitted to the processing unit. In step 206, the processing unit computes the stress distribution of the gasket, optionally based in part on the parameters inputted in step 202a. In step 208, the device 5 displays the stress distribution as a virtual gasket overlaying the test rig 20. In some embodiments, the method 200 may include repeating steps 204-208 while modifying parameters of the test rig 20, such as bolt lubrication, gasket material, type of tool for tightening, and/or bolt tightening sequence.

It is understood that variations and manufacturing techniques may be made in the foregoing without departing from the scope of the present disclosure.

In several embodiments, the elements and teachings of the various embodiments may be combined in whole or in part in some (or all) of the embodiments. In addition, one or more of the elements and teachings of the various embodiments may be omitted, at least in part, and/or combined, at least in part, with one or more of the other elements and teachings of the various embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

Although several embodiments have been described in detail above, the embodiments described are illustrative only and are not limiting, and those skilled in the art will readily appreciate that many other modifications, changes and/or substitutions are possible in the embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. An augmented reality gasket stress simulator system for bolted joint assembly training, comprising:
a test rig comprising a pair of flanges and a plurality of bolts securing the flanges together;
a tool configured to tighten or loosen the plurality of bolts;
one or more sensors associated with the bolts and/or the tool to collect bolt stress data representing an axial stress of each of the plurality of bolts;
a processing unit configured to receive the bolt stress data from the one or more sensors and compute a gasket stress distribution based on the bolt stress data; and
an augmented reality visualization device configured to overlay a virtual gasket onto a real-world view of the test rig, wherein the virtual gasket displays the computed gasket stress distribution.

2. The system of claim 1, wherein the plurality of bolts comprises instrumented bolts configured to measure axial stress applied during tightening.

3. The system of claim 2, wherein the test rig comprises two ASME B 16.5 blind flanges DN 4″ class 150 # with eight instrumented ⅝″ bolts.

4. The system of claim 1, wherein the virtual gasket displays the computed gasket stress distribution using a color-coded scale.

5. The system of claim 1, wherein the augmented reality visualization device is a tablet, a computer, a smartphone, or an augmented reality headset.

6. The system of claim 1, wherein the processing unit is configured to compute the gasket stress distribution based in part on a gasket material input.

7. The system of claim 6, wherein the processing unit is configured to compute the gasket stress distribution for a gasket material selected from compressed fiber gaskets, metallic gaskets, expanded PTFE gaskets, restructured PTFE gaskets, or skived PTFE gaskets.

8. The system of claim 1, wherein the tool comprises a torque wrench.

9. The system of claim 8, wherein the torque wrench comprises the one or more sensors.

10. The system of claim 9, wherein the plurality of bolts do not comprise sensors.

11. A method for gasket assembly training using augmented reality, comprising:
providing a test rig comprising a pair of flanges and a plurality of bolts securing the flanges together;
tightening, using a tool, the plurality of bolts;
measuring an axial stress applied to each of the plurality of bolts during the tightening using one or more sensors associated with the plurality of bolts and/or the tool;
computing, using a processing unit, a gasket stress distribution based on the measured axial stress data; and
displaying, on an augmented reality visualization device, a virtual gasket overlaid onto a real-world view of the test rig, wherein the virtual gasket displays the computed gasket stress distribution.

12. The method of claim 11, wherein the plurality of bolts comprises instrumented bolts configured to measure axial stress applied during tightening.

13. The method of claim 11, wherein the virtual gasket displays the computed gasket stress distribution using a color-coded scale.

14. The method of claim 13, wherein the color-coded scale displays stress levels at specific percentages of a desired gasket stress, including at least 25%, 50%, 75%, and 100% stress levels.

15. The method of claim 11, wherein the augmented reality visualization device is a tablet, a computer, a smartphone, or an augmented reality headset.

16. The method of claim 11, wherein the processing unit is configured to compute the gasket stress distribution based in part on a gasket material input.

17. The method of claim 16, wherein the processing unit is configured to compute the gasket stress distribution for a gasket material selected from compressed fiber gaskets, metallic gaskets, expanded PTFE gaskets, restructured PTFE gaskets, or skived PTFE gaskets.

18. The method of claim 11, wherein the tool comprises a torque wrench comprising the one or more sensors.

19. The method of claim 11, further comprising adjusting at least one assembly parameter and observing in real time the effect on the gasket stress distribution through the augmented reality visualization device.

20. The method of claim 19, wherein the at least one assembly parameter is bolt lubrication, type of tool, gasket material, or a bolt tightening sequence.
